(19) United States
(12) Patent Application Publication
(10) Pub. No.: US 2009/0067342 A1
(43) Pub. Date: Mar. 12, 2009

(54) H.248.1 Topology Descriptor

(76) Inventors: Jan Erik Lindquist, Hagersten (SE); Michael Nils Olov Lindstrom, Tullinge (SE)

Correspondence Address: ERICSSON INC., 6300 LEGACY DRIVE, M/S EVR 1-C-11, PLANO, TX, 75024, US

(21) Appl. No.: 11/718,561

(22) PCT Filed: Sep. 26, 2005
(86) PCT No.: PCT/IB05/03466

§ 371 Date: May 3, 2007

Related U.S. Application Data
(60) Provisional application No. 60/624,746, filed on Nov. 3, 2004.

(51) Int. Cl. H04L 12/28

(52) U.S. Cl. 370/254

(57) ABSTRACT

A new H.248.1 topology descriptor (T1, T2 onewayexternal) is described herein which can be used by a media gateway controller (100) to instruct a media gateway (110) to set-up an internal connection between termination T1 and termination T2 that allows a monitoring center to use termination T2 to monitor media which is being sent externally from termination T1.

### CLAIMING BENEFIT OF PRIOR FILED U.S. PATENT APPLICATION

This application claims the benefit of U.S. Provisional Application Ser. No. 60/624,746 filed on Nov. 3, 2004 and entitled “Enhancement to H.248 Topology Descriptor”, the contents of which are incorporated by reference herein.

### BACKGROUND OF THE INVENTION

1. Field of the Invention

The present invention relates in general to the telecommunications field and, in particular, to a new H.248.1 topology descriptor referred to herein as (T1, T2 onewayexternal) which can be used by a media gateway controller (MGC) to instruct a media gateway (MG) to set-up an internal connection between termination T1 and termination T2 that allows a monitoring center (for example) to use termination T2 to monitor media which is being sent externally from termination T1 to a subscriber (for example).

2. Description of Related Art

Today it is common for a study group/committee to review and make suggested changes to a telecommunication standard. Typically, the study group/committee suggests changes such as adding a new feature or revising an old feature to enhance the telecommunication standard. One such change that has been suggested in order to enhance the ITU-T H.248.1 gateway protocol standard involves the addition of a new topology descriptor which is the subject of the present invention.

### BRIEF DESCRIPTION OF THE INVENTION

The present invention includes a MGC that can use a new (T1, T2, onewayexternal) topology descriptor to command a MG to set-up an internal connection between termination T1 and termination T2 that allows a monitoring center (for example) to use termination T2 to monitor media which is being sent externally from termination T1 to a subscriber (for example). In one application, the MGC can use the new (T1, T2, onewayexternal) topology descriptor and a traditional (T1, T2, oneway) topology descriptor to enable the monitoring center to monitor the communications to and from a subscriber A that is in a three-way party call with two other subscribers B and C.

### BRIEF DESCRIPTION OF THE DRAWINGS

A more complete understanding of the present invention may be obtained by reference to the following detailed description when taken in conjunction with the accompanying drawings wherein:

FIG. 1 is a block diagram of a MGC and a MG that are able to utilize the (T1, T2, onewayexternal) topology descriptor of the present invention;

FIG. 2 (PRIOR ART) is a diagram of a context model within the MG that was established using known topology descriptors which enabled a two way call between subscribers A and B and also enabled a monitoring center to monitor/intercept their communications;

FIG. 3 (PRIOR ART) is a diagram of a context model within the MG that was established using known topology descriptors which enabled a three way conference call between subscribers A, B and C and also enabled a monitoring center to monitor/intercept the communications to and from subscriber A;

FIG. 4 is a diagram of a context model within the MG that was established using traditional topology descriptors in addition to the new (T1, T2, onewayexternal) topology descriptor to enable a three way conference call between subscribers A, B and C and to enable a monitoring center to monitor/intercept the communications to and from subscriber A in accordance with the present invention; and

FIG. 5 is a flowchart illustrating the steps of a method for enabling a monitoring center to monitor the communications to and from a subscriber A that is in a three-way party call with two other subscribers B and C in accordance with the present invention.

### DETAILED DESCRIPTION OF THE DRAWING

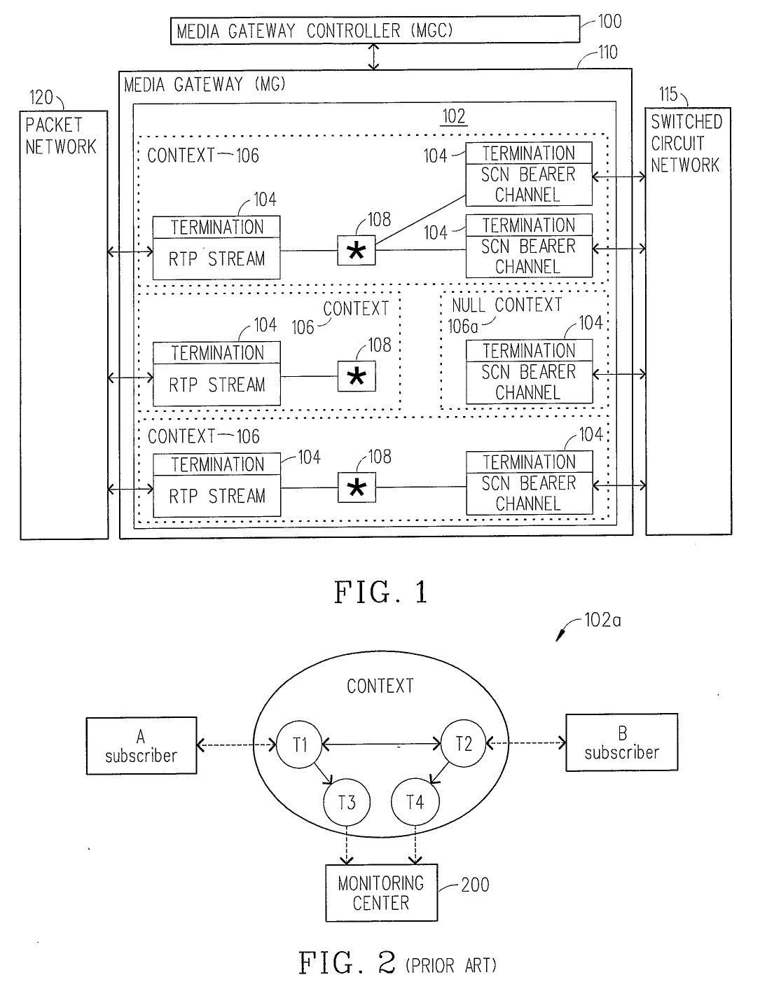

Referring to FIG. 1, there is shown a block diagram of a MGC 100 and a MG 110 that can utilize the (T1, T2, onewayexternal) topology descriptor of the present invention. For clarity, a detailed discussion about the new (T1, T2, onewayexternal) topology descriptor is provided after a brief discussion about the basic structure and functions of the MGC 100 and the MG 110. It should also be noted that for clarity the description provided below in relation to the MGC 100 and MG 110 omits certain details and components that are well known in the industry and are not necessary to understand the present invention.

The MG 110 basically functions to convert media provided in one type of network to the format required in another type of network. For example, the MG 110 could terminate switch circuit network (SCN) bearer channels (e.g., DSOs) from a switched circuit network 115 and media streams (e.g., Real-time Transport (RTP) streams) from a packet network 120 (e.g., Internet Protocol (IP) network 120). The MG 110 is capable of full duplex media translations and is also capable of processing audio, video and T.120 alone or in any combination. The MG 110 may also play audio/video messages and perform Interactive Voice Response (IVR) functions, or perform media conferencing (for example). And, the MGC 100 basically functions to control the parts of a call state that pertains to the control of the connection for media channels in the MG 110.

FIG. 1 shows the logical entities/objects of an exemplary H.248.1 connection model 102 within the MG 110 that are established and controlled by the MGC 100. The main abstractions used in the connection model 102 are terminations 104 and contexts 106. A termination 104 is a logical entity in the MG 110 that sources and/or sinks media and/or control streams. And, a context 106 is an association between a number of terminations 104. A special type of context 106 is also shown which is known as a null context 106a. The null context 106a contains all of the terminations 104 that are not present in any other context 106 and therefore are not associated to any other termination 104. In general, an ADD command is used to add a termination 104 to a context 106. If the MGC 100 does not specify an existing context 106 to which the new termination 104 is to be added, then the MG 110 creates a new context 106. A termination 104 may be removed from a context 106 with a SUBTRACT command, and a termination 104 may be moved from one context 106 to another context 106 with a MOVE command. A termination 104 can exist in only one context 106 at a time. And, the asterick box 108 in each of the contexts 106 represents the logical association of terminations 104 implied by the particular context 106. For a more detailed discussion about the logical entities/objects of the MGC 100 and MG 110, reference is made to:

ITU-T Recommendation H.248.1: Gateway Control Protocol: Version 2 (May 2002).

The contents of this document are incorporated by reference herein.

Next, a problem associated with the traditional H.248.1 standard is described and then a description is provided about how that problem can be solved by using the new (T1, T2, onewayexternal) topology descriptor in accordance with the present invention. In the past, the traditional H.248.1 standard supported three topology descriptors which were used to specify flow directions between terminations 104 in a context 106. These topology descriptors include a sequence of associated terminations 104 having the form (T1, T2, association[,StreamId]), where T1 and T2 specify terminations 104 within the context 106 which can be selected using an ALL or CHOOSE wildcard. If the optional StreamId field is used, the association applies only to the particular stream between T1 and T2 labeled by the StreamId. If the StreamId field is omitted, the topology applies to all streams in the termination 104. The association specifies how media flows between T1 and T2 as follows:

(T1, T2, isolate) means that the terminations matching T2 do not receive media from the terminations matching T1, nor vice versa.

(T1, T2, oneway) means that the terminations that match T2 receive media from the terminations matching T1, but not vice versa. In this case, use of the ALL wildcard such that there are terminations that match either T1 or T2 but not both is allowed.

(T1, T2, bothway) means that the terminations matching T2 receive media from the terminations matching T1, and vice versa. In this case, it is allowed to use wildcards such that there are terminations that match both T1 and T2. However, if there is a termination that matches both, no loop-back is introduced.

These known topology descriptors work well in setting-up internal connections in the MG 110 for purposes like establishing a two party call and then enabling a monitoring center (for example) to lawfully monitor/intercept the communications in that two party call. This scenario is shown in FIG. 2 (PRIOR ART) which illustrates a diagram of a connection model 102a within the MG 110 where subscriber A and subscriber B are engaged in a two party call and a monitoring center 200 lawfully monitors/intercepts their communications. To establish this two party call with lawful interception, the MGC 100 sends a command with traditional topology descriptors to the MG 110 as follows:

```
MGC to MG:
MEGACO/1 [123.123.123.4]:55555
Transaction = 10001 {
    Context = $ {
      Topology {*,T3,isolate,*,T4,isolate,T1,T3,oneway,
T2,T4,oneway
}
      Add = T1 {
}
Add = T2 {
}
      Add = T3 {
}
Add = T4 {
}
    }
        }
```

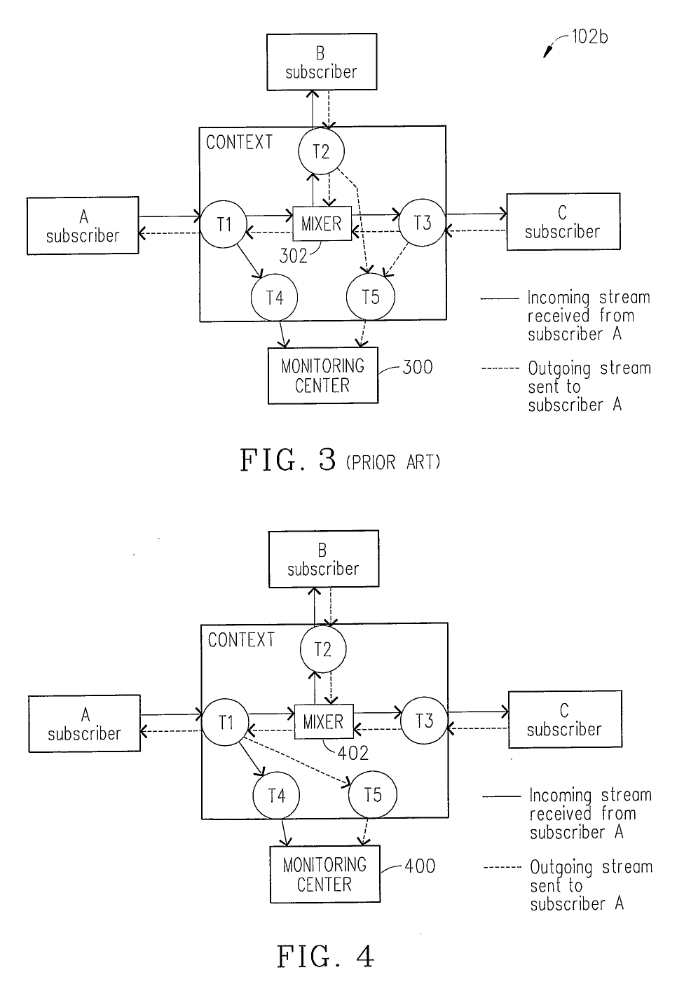

Although the known topology descriptors used to establish the aforementioned connection model 102a for the two party call work fine, they don't work as well for more complicated scenarios. For instance, take the connection model 102b shown in FIG. 3 (PRIOR ART) where there is a three way conference call between subscribers A, B and C and a monitoring center 300 which lawfully monitors/intercepts the communications to and from subscriber A. To establish the three way conference call between subscribers A, B and C, the MGC 100 sends a number of commands which contain the traditional topology descriptors to the MG 110 as follows:

```
MGC to MG:
MEGACO/1 [123.123.123.4]:55555
Transaction = 10001 {
    Context = $ {
Topology {*,T4,isolate,*,T5,isolate,T1,T4,oneway,
T2,T5,oneway,T3,T5,oneway
}
Add = T1 {
}
Add = T2 {
}
      Add = T3 {
}
Add = T4 {
}
Add = T5 {
}
    }
        }
```

In this example, subscriber A is to be monitored by the monitoring center 300 which is connected to terminations T4 and T5. As shown, T5 wants the streams sent to subscriber A from subscribers B and C. And, T4 wants the stream received from subscriber A. For T4 to monitor the incoming stream from subscriber A, the following command which contains traditional topology descriptors would need to be used:

```
MGC to MG:
MEGACO/1 [123.123.123.4]:55555
Transaction = 10001 {
    Context = 1 {
        Topology {*,T4,isolate, T1,T4,oneway},
        Add = T4
        }
    }
}
```

And, for T5 to monitor the streams sent to subscriber A from subscribers B and C, the following command with traditional topology descriptors would need to be used:

```
MGC to MG:
MEGACO/1 [123.123.123.4]:55555
Transaction = 10002 {
    Context = 1 {
        Topology {*,T5,isolate,T2,T5,oneway,T3,T5,oneway},
        Add = T5
        }
    }
}
```

At first glance, the use of the traditional topology descriptors to establish T4 and T5 appears to be fairly straightforward and simple. However, if subscribers A, B and C used a mixing volume level control according to H.248.19 § 11.4, then things get complicated. For instance, assume subscriber A controls the volume level and it is mixed such that subscriber B is at 15 db and subscriber C is at 20 db. In this scenario, since T4 monitors the incoming stream from subscriber A then there would be no change in the topology as it would receive the incoming stream at one volume level. However, the mixing of the volume levels would become complicated for T5 because when T5 is added it would need to have the same mixing properties as T1. To make this happen the MGC 100 would need to issue the following command:

```
MGC to MG:
MEGACO/1 [123.123.123.4]:55555
Transaction = 10002 {
    Context = 1 {
        Topology {*,T5,isolate ,T2,T5,oneway,T3,T5,oneway},
            Add = T5 {
      Media {
                    Stream = 1 {
                      p/vollevip = 0,15,20
                    },
        }
    }
}
```

As can be seen, to properly control the volume level associated with T5, a command with an additional level of functionality is required. This is not desirable.

A discussion is provided next about yet another problem that can occur in the three party conference call scenario shown in FIG. 3. This problem occurs when the MGC 100 requests the MG 110 to play an announcement (i.e. pre-recorded message) to subscriber A. Referring first to T4, there would be no effect on T4 since the topology descriptor {T1, T4, oneway} ensures that only an stream from subscriber A is heard by the monitoring center 300. As such, T4 would not and is not suppose to receive the announcement. Reference is now made to T5, which should and does receive the announcement that is made to subscriber A. However, in view of this particular topology, T5 also receives streams from T2 and T3. And, if the announcement is played on either T2 or T3 internally this means that apart from T5 one of T2 or T3 (i.e., the one not playing the announcement) will also receive a copy of the announcement. This is due to the function of a mixer 302 and is not desirable. A solution to this problem is that the announcement should be played simultaneously on both T1 and T5. However, this results in a need to send an extra command to T5. This is not desirable.

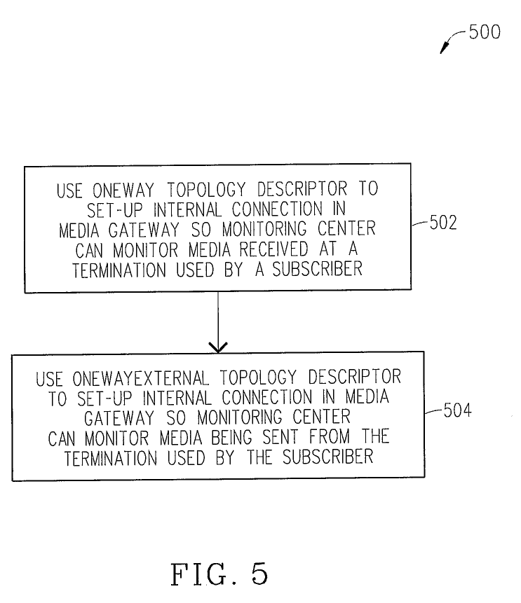

The aforementioned example illustrates that the commands become complicated very quickly in order to ensure T5 receives the media that T1 is sending externally to subscriber A. This complication is caused by the fact that the MGC 100 needs to operate on both T1 and T5 whenever it wants to do something on T1. The new onewayexternal topology descriptor of the present invention can be used to solve this problem. A detailed description about the new onewayexternal topology descriptor and how it can be used to solve this and other problems is provided below with respect to FIGS. 4 and 5.

The present invention involves the use of a new topology descriptor: topology (T1, T2, onewayexternal). The topology descriptor (T1, T2, onewayexternal) means the terminations that match T2, receive media sent by terminations matching T1, but not vice versa. In this case, the use of the ALL wildcard for T1 is not allowed. It should be noted that the use of T1 and T2 in topology descriptor (T1, T2, onewayexternal) should not be confused with terminations T1 and T2 used in the examples shown in FIGS. 2-4.

A purpose of the new onewayexternal topology description is to simplify how the media that a particular termination is sending can be monitored. To help explain how this can be done, the three party conference call scenario discussed above with respect to FIG. 3 is used along with the scenario shown in FIG. 4. Basically, the command which creates and enables T5 to monitor the streams sent to subscriber A from subscribers B and C would change from (see FIG. 3):

```
MGC to MG:
MEGACO/1 [123.123.123.4]:55555
Transaction = 10002 {
    Context = 1 {
        Topology {*,T5,isolate, T2,T5,oneway,T3,T5,oneway},
        Add = T5
        }
    }
}
```

### to (see FIG. 4):

```
MGC to MG:
MEGACO/1 [123.123.123.4]:55555
Transaction = 10002 {
    Context = 1 {
        Topology {*, T5, isolate, T1,T5,onewayexternal},
        Add = T5
        }
    }
}
```

FIG. 4 is a block diagram that illustrates how a three party conference call between subscribers A, B and C and a monitoring center 400 which lawfully monitors/intercepts the communications to and from subscriber A can be established in accordance with the present invention. It should be noted that the monitoring center 400 can monitor/intercept in stereo or mono the communications that are sent to and received from subscriber A. First, the MGC 100 could establish the three party conference call using the following commands:

```
MGC to MG:
MEGACO/1 [123.123.123.4]:55555
Transaction = 10002 {
    Context = 1 {
Add = T1 {
}
Add = T2 {
}
      Add = T3 {
}
    }
}
```

Then, the MGC 100 would establish T4 and T5 so that monitoring center 400 can monitor/intercept the communications to and from subscriber A. To accomplish this, the MGC 100 would issue the following commands:

```
MGC to MG:
MEGACO/1 [123.123.123.4]:55555
Transaction = 10001 {
    Context = 1 {
        Topology {*, T4, isolate, T1,T4,oneway},
        Add = T4
        }
    }
}
MGC to MG:
MEGACO/1 [123.123.123.4]:55555
Transaction = 10002 {
    Context = 1 {
        Topology {*, T5, isolate, T1,T5,onewayexternal},
        Add = T5
        }
    }
}
```

In this case, if mixing volume level control is added to T1, then there is no additional signalling needed as T5 would get the mixed stream (which is mixed by mixer 402) that is being sent externally by T1. And, if an announcement was played on T1, again there would be no reason for additional commands as T5 would receive the stream that is being played externally. In fact, no additional commands for T5 would be needed for any type a media manipulation at T1 when the onewayexternal topology descriptor is used. As can be seen, the new onewayexternal topology descriptor simplifies the handling of external streams. And, since the new onewayexternal topology descriptor can enhance the traditional H.248.1 gateway control protocol, it has been incorporated into version 3 of the ITU-T H.248.1 gateway control protocol.

From the foregoing, it can be readily appreciated by those skilled in the art that the present invention provides a method 500 for enabling a monitoring center 400 to monitor communications to and from a subscriber (e.g., subscriber A) that is taking part in a three-way party call with two other subscribers (e.g., subscribers B and C) (see FIG. 5). To accomplish this, the MGC 100 would need to send a command with an oneway topology descriptor to the MG 110 instructing the MG 110 to set-up an internal connection between a first termination (e.g., termination T1) used by subscriber A and a second termination (e.g., termination T4) used by the monitoring center 400 to monitor media which is being received at the first termination (e.g., termination T1) from subscriber A (see FIG. 4 and step 502 in FIG. 5). And, the MGC 100 would need to send a command with an onewayexternal topology descriptor to the MG 110 instructing the MG 110 to set-up an internal connection within the MG 110 between the first termination (e.g., termination T1) used by subscriber A and a third termination (e.g., termination T5) used by the monitoring center 400 to monitor media which is being sent externally from the first termination (e.g., termination T1) to subscriber A (see FIG. 4 and step 504 in FIG. 5). It should be appreciated that the onewayexternal topology descriptor can be used in other scenarios like a multi-party call scenario in addition to the aforementioned three party conference call scenario.

Although one embodiment of the present invention has been illustrated in the accompanying Drawings and described in the foregoing Detailed Description, it should be understood that the invention is not limited to the embodiment disclosed, but is capable of numerous rearrangements, modifications and substitutions without departing from the spirit of the invention as set forth and defined by the following claims.

What is claimed is:

1. A media gateway that receives a command with an onewayexternal topology descriptor and sets-up an internal connection within a context between a first termination and a second termination that allows one to use said second termination to monitor media which is being sent externally from said first termination.

2. The media gateway of claim 1, wherein said onewayexternal topology descriptor is defined such that terminations which match said second termination receive media sent externally by terminations matching said first termination, but not vice versa.

3. The media gateway of claim 1, wherein said onewayexternal topology descriptor does not support the use of an ALL wildcard for said first termination.

4. The media gateway of claim 1, wherein if mixing volume control is added to said first termination then no additional commands are needed for said second termination because said second termination receives the mixed media that is being sent externally from said first termination.

5. The media gateway of claim 1, wherein if an announcement is played on said first termination then no additional commands are needed for said second termination because said second termination receives the announcement that is being sent externally from said first termination.

6. The media gateway of claim 1, wherein said onewayexternal topology descriptor is supported by ITU-T H.248.1 gateway control protocol.

7. A media gateway controller that sends a command with a topology descriptor having a form (T1, T2, onewayexternal) to a media gateway which causes said media gateway to set-up an internal connection within a context between termination T1 and termination T2 that allows one to use said termination T2 to monitor media which is being sent externally by said termination T1.

8. The media gateway controller of claim 7, wherein said (T1, T2, onewayexternal) topology descriptor is defined such that terminations which match said T2 receive media sent externally by terminations matching said T1, but not vice versa.

9. The media gateway controller of claim 7, wherein said (T1, T2, onewayexternal) topology descriptor does not support the use of an ALL wildcard for said T1.

10. The media gateway controller of claim 7, wherein if any media manipulation is applied to said T1 then no additional commands are needed for said T2 because said T2 receives the media that is being sent externally from said T1.

11. The media gateway controller of claim 10, wherein said media manipulation that is applied to T1 includes mixing volume control and/or playing an announcement.

12. The media gateway controller of claim 17, wherein said media gateway supports a ITU-T H.248.1 gateway control protocol which means that said media gateway in addition to supporting said (T1, T2, onewayexternal) topology descriptor also supports:
a (T1, T2, isolate) topology descriptor;
a (T1, T2, oneway) topology descriptor; and
a T1, T2, bothway) topology descriptor.

13. A method for enabling a monitoring center to monitor communications to and from a subscriber taking part in a multi-party call, said method comprising the steps of:
using an oneway topology descriptor to set-up an internal connection within a media gateway between a first termination used by said subscriber and a second termination used by said monitoring center to monitor media which is being received at said first termination from said subscriber; and
using an onewayexternal topology descriptor to set-up an internal connection within the media gateway between the first termination used by said subscriber and a third termination used by said monitoring center to monitor media which is being sent externally from said first termination to said subscriber.

14. The method of claim 13, wherein:
said oneway topology descriptor is defined such that terminations which match said second termination receive media from terminations matching said first termination; and
said onewayexternal topology descriptor is defined such that terminations which match said third termination receive media sent externally by terminations matching said first termination, but not vice versa.

15. The method of claim 13, wherein said onewayexternal topology descriptor does not support the use of an ALL wildcard for said first termination.

16. The method of claim 13, wherein said monitoring center can monitor the media being sent to and received from said subscriber in stereo or mono.

17. The method of claim 13, wherein said media gateway supports an H.248.1 gateway control protocol.
